(19) United States
(12) Patent Application Publication
(10) Pub. No.: US 2006/0291469 A1
(43) Pub. Date: Dec. 28, 2006

(54) Computer-readable recording medium storing worm detection program, worm detection method and worm detection device

(75) Inventors: Kazumasa Omote, Kawasaki (JP); Yoshiki Higashikado, Kawasaki (JP); Masahiro Komura, Kawasaki (JP); Bintatsu Noda, Kawasaki (JP); Masashi Mitomo, Kawasaki (JP); Satoru Torii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/348,335

(22) Filed: Feb. 7, 2006

(30) Foreign Application Priority Data
Jun. 28, 2005 (JP) 2005-187772

(51) Int. Cl. H04L 12/56

(52) U.S. Cl. 370/392; 370/401

(57) ABSTRACT

A computer-readable recording medium recording a worm detection program which is preferably usable for a large-scale network and is capable of detecting worm communication with little information. A worm detection device which runs this program has a switching hub function, and comprises five physical ports that are network interfaces, a communication acquisition section, and a worm detector, for example. The communication acquisition section acquires ICMP type3 (destination unreachable message) packets going out of the physical ports. The worm detector determines whether the packet communication is worm communication, based on information on the ICMP type3 packets obtained for each source MAC address by the communication acquisition section and worm criteria set for determining whether communication is worm communication.

### CROSS-REFERENCE TO RELATED APPLICATIONS

This application is based upon and claims the benefits of priority from the prior Japanese Patent Application No. 2005-187772, filed on Jun. 28, 2005, the entire contents of which are incorporated herein by reference.

### BACKGROUND OF THE INVENTION

(1) Field of the Invention

This invention relates to a computer-readable recording medium storing a worm detection program, a worm detection method and a worm detection device. Specifically, this invention relates to a computer-readable recording medium storing a worm detection program, a worm detection method and a worm detection device, for detecting worm communication by monitoring communication of prescribed network segments being connected to a network.

(2) Description of the Related Art

There has been known methods for detecting a worm that is a malicious program making the distribution of copies of itself without other programs.

As an example, there has been proposed a method of determining a worm-infected terminal depending on whether the terminal is continuously accessing a subnetwork which does not exist in a Local Area Network (LAN) (for example, refer to references 1 and 2: Japanese Patent Application Laid-open Nos. 2005-56243 and 2005-56250).

In the references 1 and 2, a source terminal is considered as accessing an unexisting subnetork if the terminal is accessing a destination Internet Protocol (IP) address that does not exist in a network structure database (DB). The network structure DB is a DB for managing the IP addresses at network borders, the IP addresses of the terminals within networks, and how the networks are connected.

In addition, focusing on worm's random scanning, there has been proposed another method of detecting worm communication by searching for a packet with a message indicating an Internet Control Message Protocol (ICMP) type of 3 (Destination unreachable), that is, an ICMP type3 message (for example, refer to reference 3: George Bakos and Vincent Berk, “Early Detection of Internet Worm Activity by Metering ICMP Destination Unreachable Messages”, Proceedings of the SPIE Aerosense 2002).

According to the reference 3, from the payload part of each ICMP type3 packet, information including a destination IP address, a source IP address, a destination port, and a protocol is first obtained. When the sender with the source IP address transmitted a prescribed number or more of packets addressed to the same destination port but different destination IP addresses in a unit time, communication from the sender with the source IP address is identified as worm communication.

In the worm detection methods disclosed in the references 1 and 2, a network structure DB should be previously prepared. This may not be suitable for a large-scale network where a network structure varies often. In addition, in the worm detection method disclosed in the reference 3, the payload part of an ICMP packet should be analyzed and a complicated detection process should be executed. Further, lots of information are required in the detection process, resulting in recording complicated information as communication log data.

### SUMMARY OF THE INVENTION

This invention has been made in view of foregoing and intends to provide a computer-readable recording medium recording a worm detection program, a worm detection method and a worm detection device, which is preferably usable for a large-scale network and are capable of detecting worm communication with little information.

To achieve the above object, there provided a computer-readable recording medium recording a worm detection program for monitoring communication of prescribed network segments being connected to a network and determining whether the communication is worm communication. This worm detection program causes a computer to function as: a communication acquisition section for obtaining information on destination address unreachable signals of packets for each source MAC address; and a worm detector for determining whether the communication is worm communication, based on the information on the destination address unreachable signals of the packets and worm criteria set for determining whether communication is worm communication, the information obtained by the communication acquisition section.

Further, to achieve the above object, there provided a worm detection method for monitoring communication of prescribed network segments being connected to a network and determining whether the communication is worm communication. In this worm detection method, a communication acquisition section obtains information on destination address unreachable signals of packets for each source MAC address, and a worm detector determines whether the communication is worm communication, based on the information on the destination address unreachable signals of the packets and worm criteria set for determining whether communication is worm communication, the information obtained by the communication acquisition section.

Still further, to achieve the above object, there provided a worm detection device for monitoring communication of prescribed network segments being connected to a network and determining whether the communication is worm communication. This worm detection device comprises: a communication acquisition section for obtaining information on destination address unreachable signals of packets for each source MAC address; and a worm detector for determining whether the communication is worm communication, based on the information on the destination address unreachable signals of the packets and worm criteria set for determining whether communication is worm communication, the information obtained by the communication acquisition section.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a worm detection device.

FIG. 2 shows a hardware structure of the worm detection device.

FIG. 3 is a functional block diagram of the worm detection device.

FIG. 4 shows an example of a structure of a communication packet.

FIG. 5 shows a structure of an Ether header.

FIG. 6 shows a structure of an IP header.

FIG. 7 shows a structure of an ICMP header.

FIG. 8 shows setting data.

FIG. 9 shows an example of a data structure of communication log data.

FIGS. 10 and 11 show examples of a data structure of block data.

FIG. 12 is a flowchart of a worn detection procedure.

FIG. 13 is a flowchart of a communication blocking procedure.

### DESCRIPTION OF THE PREFERRED EMBODIMENTS

A preferred embodiment of this invention will be described with reference to the accompanying drawings.

The invention which is implemented to the embodiment is first outlined and then the embodiment will be described in detail.

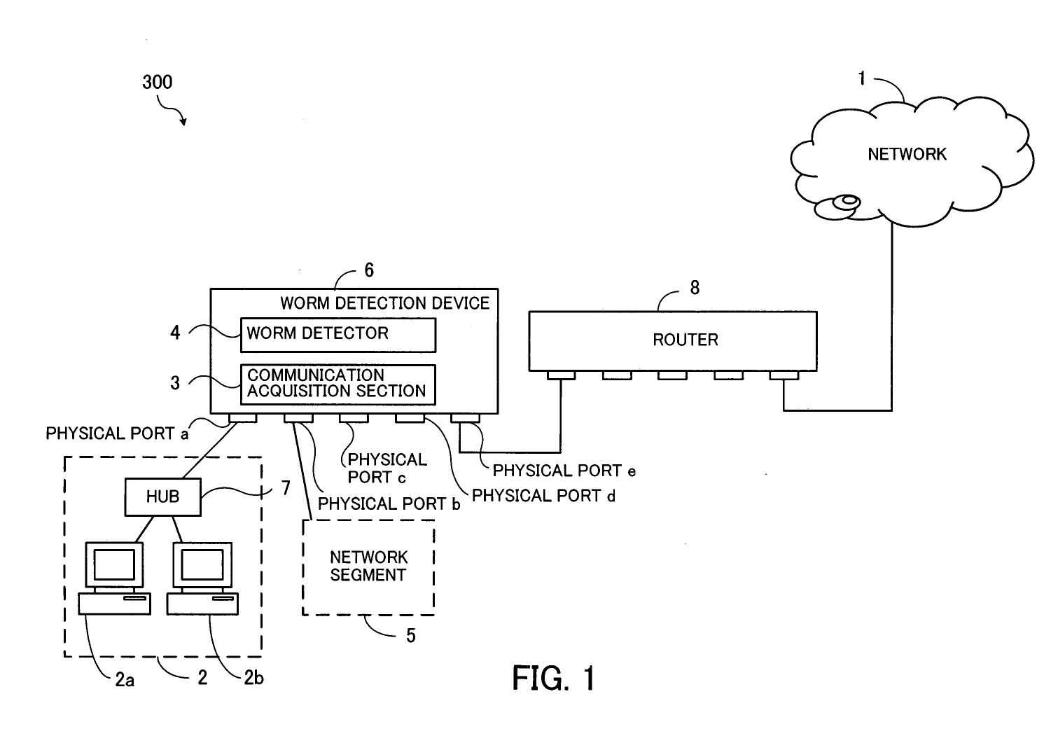

FIG. 1 is a conceptual view of a worm detection device.

In a worm detection system 300, two network segments 2 and 5 are connected to a network 1 via a worm detection device 6 and a router 8. Each network segment includes at least one server or client device. The network 1 is a notion including the Internet, an intranet, and a network of an Internet Services Provider (ISP).

The worm detection device 6 has a function like switching hub, and comprises at least one physical port (five ports a to e in FIG. 1) functioning as a network interface, a communication acquisition section 3, and a worm detector 4.

The network segment 2 includes terminals 2a and 2b, and a hub 7 being connected to the terminals 2a and 2b. The hub 7 is also connected to the worm detection device 6. That is, a plurality of terminals can be connected to the physical ports a to e via hubs.

Packets going out of the physical ports a to e are monitored by the communication acquisition section 3 of the worm detection device 6. For example, in a case of communication to the terminal 2a via the physical port a from another physical port, the communication acquisition section 3 captures the packet going out of the physical port a and the worm detector 4 determines whether the packet is worm communication. It should be noted that communication between the terminal 2b and the terminal 2a via the hub 7, not via the physical port a, is not monitored.

Specifically, the communication acquisition section 3 acquires an ICMP type3 (destination unreachable message) packet going out of the physical port a. An ICMP type3 packet is a packet that includes a message to be returned to its source MAC address if a relay node such as the router 8 cannot transfer this packet for some reasons.

The worm detector 4 determines based on obtained information whether a worm from a network segment (2 in FIG. 1, for example) is attacking computers of another network segment (5 or the network 1 in FIG. 1).

If a worm appears, the number of communication packets transmitted in a unit time increases remarkably. Therefore, the worm detection device 6 can detect worms easily and effectively.

A specific embodiment of this invention will be described.

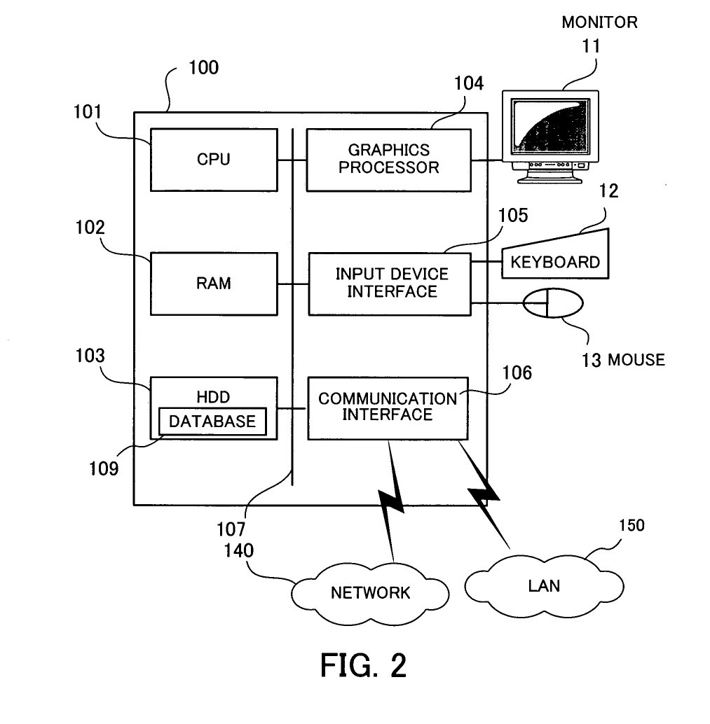

FIG. 2 shows a hardware structure of a worm detection device.

The worm detection device 100 is entirely controlled by a Central Processing Unit (CPU) 101. Connected to the CPU 101 via a bus 107 are a Random Access Memory (RAM) 102, a Hard Disk Drive (HDD) 103, a graphics processing unit 104, an input device interface 105, and a communication interface 106.

The RAM 102 temporally stores at least part of the Operating System (OS) program and application programs to be executed by the CPU 101. In addition, the RAM 102 stores various kinds of data for CPU processing. The HDD 103 stores the OS and application programs. A database 109 is created and stored in the HDD 103.

The graphics processing unit 104 is connected to a monitor 11 to display images on the monitor 11 under the control of the CPU 101. The input device interface 105 is connected to a keyboard 12 and a mouse 13 to transfer signals from the keyboard 12 and the mouse 13 to the CPU 101 via the bus 107.

The communication interface 106 is connected to a network 140 and a LAN 150. The communication interface 106 communicates data with other computers via the network 140 or the LAN 150. The LAN 150 is like an intranet.

The above hardware structure allows the processing functions of this invention to be realized. For worm detection, the worm detection device 100 constructed as above has the following functions.

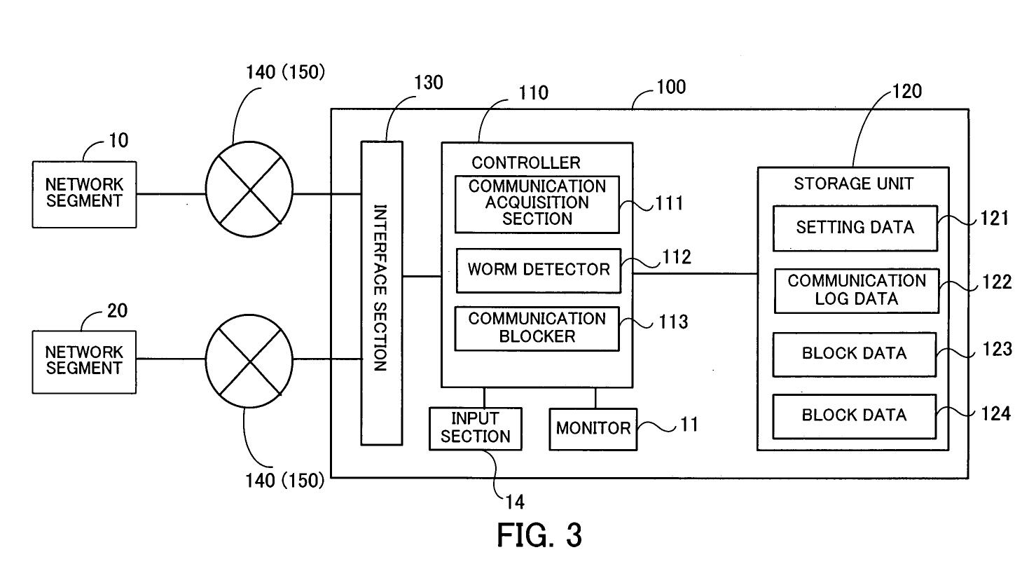

FIG. 3 is a functional block diagram of a worm detection device.

The worm detection device 100 is connected to a network segment 10 (corresponding to the network segment 2 of FIG. 1), and a network segment 20 (corresponding to the network segment 5 or the network 1 via the router 8 in FIG. 1).

The worm detection device 100 extracts information including an ICMP packet type and a destination MAC address from an acquired communication packet with reference to setting data 121 regarding the information extraction. Then this worm detection device 100 determines whether the communication is worm communication, based on the extracted information and worm criteria set for determining whether the communication is worm communication.

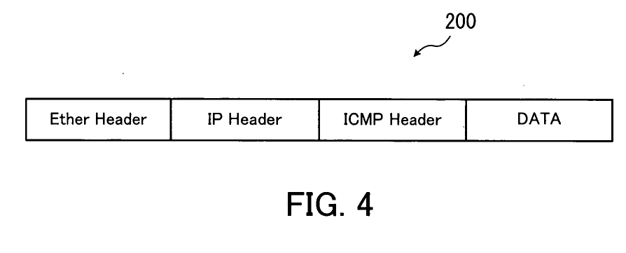

A communication packet will be described with reference to FIG. 4.

A communication packet 200 comprises Ether header, IP header, ICMP header, and data in order.

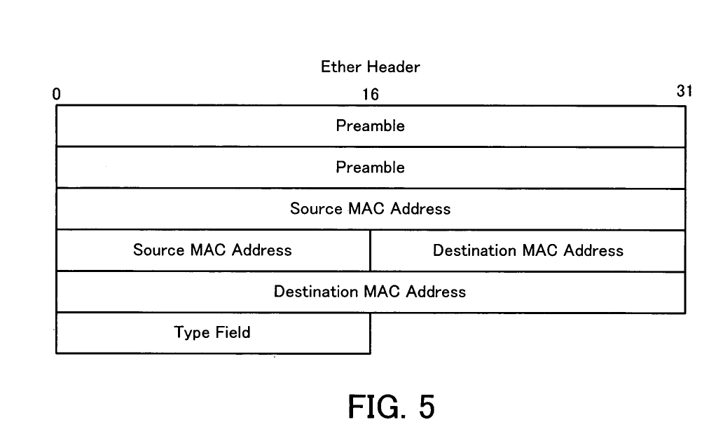

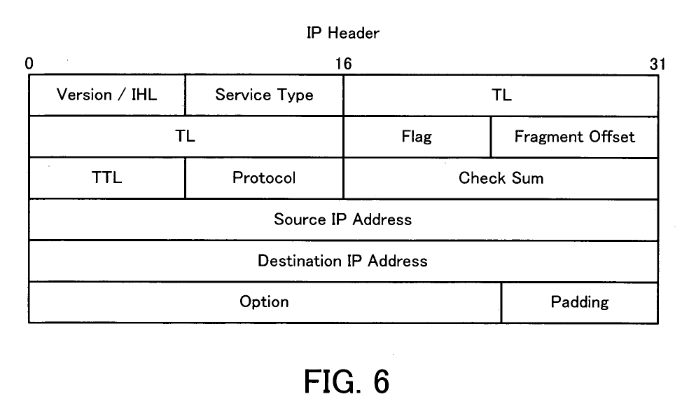

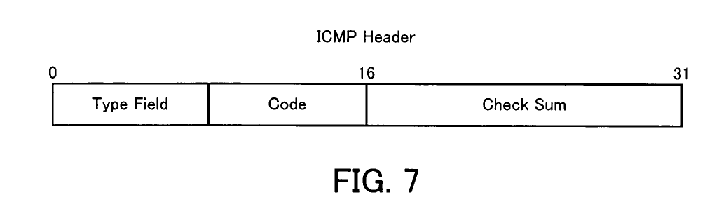

Referring to FIG. 5, the Ether header is represented in 32 bits for each line for clear understanding (the same goes for FIGS. 6 and 7). The Ether header comprises preamble, source MAC address, destination MAC address, and type field in order.

Referring to FIG. 6, the IP header comprises version/internet header length (IHL), service type, total length (TL), flag, fragment offset, time to live (TTL), protocol, header checksum (Checksum), source IP address, destination IP address, option, and padding.

Referring to FIG. 7, the ICMP header comprises type field, code, and checksum.

Referring back to FIG. 3, the worm detection device 100 has a controller 110, an input section 14, the monitor 11, a storage unit 120, and an interface section 130.

The controller 110 has a communication acquisition section 111, a worm detector 112, and a communication blocker 113. Further, the controller 110 is connected to the input section 14 and the monitor 11. The input section 14 includes input devices such as the keyboard 12 and the mouse 13.

The storage unit 120 is a storage device such as the RAM 102 or the HDD 103. This storage unit 120 stores the setting data 121, communication log data 122, and block data 123 and 124.

The interface section 130 includes a plurality of physical ports including physical ports 1 and 2 which are unillustrated and described later, and is a network interface for relaying communication data between the network segments 10 and 20 via the network 140 and the LAN 150.

The communication acquisition section 111 obtains information including the communication address and protocol from a communication packet with reference to the setting data 121 being stored in the storage unit 120. Specifically, the communication acquisition section 111 extracts a value set in the type field of the ICMP packet and a destination MAC address, from the fixed-length part of the packet 200, the fixed-length part including the Ether header, the IP header and the ICMP header. In addition, the communication acquisition section 111 sets the number of ICMP type3 packets for each destination MAC address in the communication log data 122. The communication log data 122 may be stored on the RAM 102.

Based on the information obtained by the communication acquisition section 111 and the setting data 121 being stored in the storage unit 120, the worm detector 112 counts the number of ICMP type3 packets for each source MAC address, in order to determine whether communication from the source MAC address is worm communication.

When the worm detector 112 determines packet communication as worm communication, the communication blocker 113 blocks the worm packet communication. Here, there are two methods of blocking. The communication blocker 113 can block communication based on a destination MAC address or a physical port that is specified in a worm detection process described later. One method is blocking on a MAC address basis. This method enables blocking of communication from a terminal with a worm-infected source MAC address (hereinafter, infected terminal). In a case where a plurality of terminals are connected to one physical port, this method can block communication only from infected terminals while allowing communication from the other terminals. The other method is blocking on a physical port basis. This can previously avoid communication from terminals using the same physical port as an infected terminal in case the terminals are also infected.

The setting data 121 shows specifications set for extracting information including the communication addresses and protocols of communication packets, and worm criteria set for determining whether communication is worm communication.

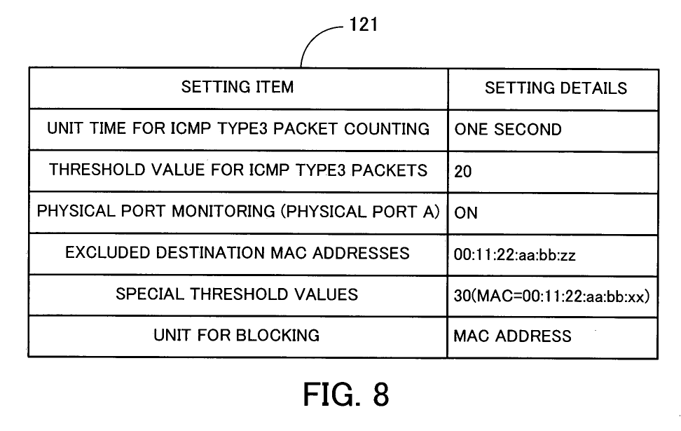

Referring to FIG. 8, the setting data 121 comprises setting items and setting details in association with each other. The setting items show what kinds of items are specified and the setting details are confirmed at the beginning of the worm detection process. The setting details are setting information to be referenced at a time of accepting the setting for the setting data 121.

Specifically, the setting items are “unit time for ICMP type3 packet counting”, “threshold value for ICMP type3 packets”, “physical port monitoring”, “excluded destination MAC addresses”, “special threshold values”, and “unit for blocking”.

The “unit time for ICMP type3 packet counting” shows a period of time during which the number of ICMP type3 packets is counted. For example, a unit time of one second means that the number of ICMP type3 packets for one second is counted for each destination MAC address.

The “threshold value for ICMP type3 packets” shows a threshold value based on which the worm detector 112 determines whether communication is worm communication. In this figure, 20 is set as this threshold value.

The “physical port monitoring” can be set for each physical port of the worm detection device 100. Here, setting details for a physical port A are specified. The physical port monitoring of ON enables monitoring while OFF disables monitoring. This setting item is settable for each physical port.

As the “excluded destination MAC addresses”, one or more destination MAC addresses to be excluded from counting of ICMP type3 packets can be set. This figure shows “00:11:22:aa:bb:zz” as an excluded destination MAC address. The MAC addresses set in this “excluded destination MAC addresses” are not added to the communication log data 122 as new destination MAC addresses. If an excluded destination MAC address is added as a new destination MAC address, this address is excluded from counting of ICMP type3 packets. This is effective in a case where an administration terminal sends an echo request message (ICMP Type8) to the address space of a network to confirm existence of terminals and recognizes a plurality of ICMP type3 packets in a short time. That is, the MAC address of this administration terminal can be excluded from counting of ICMP type3 packets by setting the MAC address as an “excluded destination MAC address”. Therefore, it is possible to avoid erroneous detection of worms easily and reliably.

In the “special threshold values”, one or more threshold values each unique to a destination MAC address can be set. Special threshold values are preferentially referenced. In this figure, 30 is set as a special threshold value for a destination MAC address “00:11:22:aa:bb:xx”. Therefore, the threshold value for the destination MAC address “00:11:22:aa:bb:xx” is 30 although the “threshold value for ICMP type3 packets” shows 20.

As the “unit for blocking”, one out of the two above-described blocking methods can be set. “MAC address” makes the communication blocker 113 to block communication on a MAC address basis while “physical port” enables blocking on a physical port basis. In this figure, “MAC address” is set.

Referring back to FIG. 3, the communication log data 122 is a table showing the number of ICMP type3 packets for each combination of a physical port and a destination MAC address.

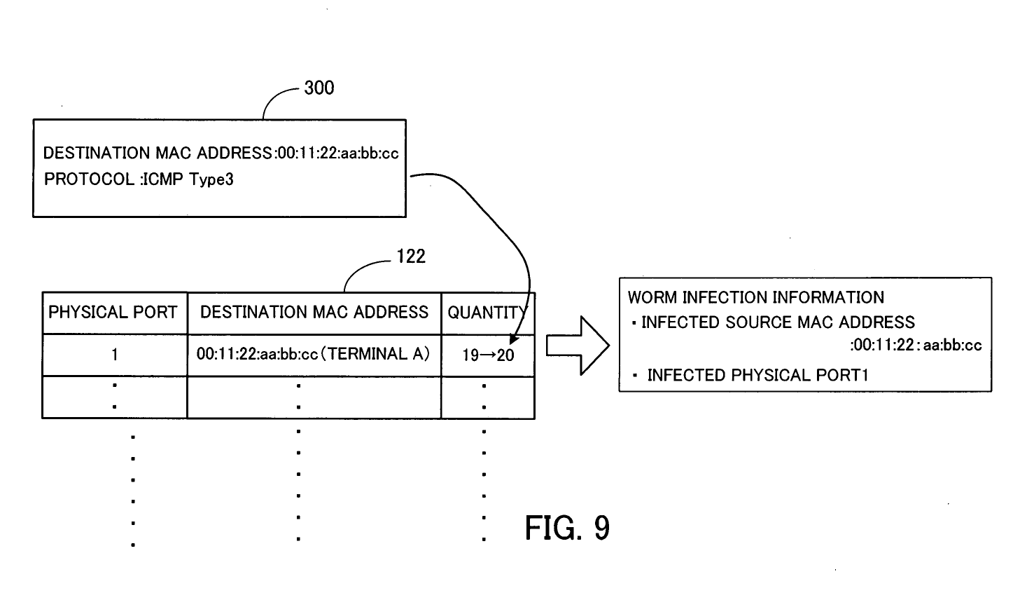

FIG. 9 shows a data structure of communication log data.

The communication log data 122 shows physical port, destination MAC address and quantity on each row.

The quantity shows the number of ICMP type3 packets appearing in a unit time. When the number of ICMP type3 packets regarding a combination of a physical port and a destination MAC address in a unit time reaches or exceeds a corresponding threshold value, it is recognized that a worm is appearing. Assume now that a packet 300 to be sent to the network segment 10 shows a physical port of 1, a destination MAC address of “00:11:22:aa:bb:cc”, and a type field of 3. Since the physical port 1 and the destination MAC address “00:11:22:aa:bb:cc” are already registered in the communication log data 122, the number of the quantity is incremented from 19 to 20. Since 20 is set as the “threshold value for ICMP type3 packets” of the setting data 121, the quantity reaches the threshold value. As a result, the worm detector 112 determines the terminal A with the destination MAC address “00:11:22:aa:bb:cc” as a worm-infected terminal. Because the terminal A is connected to the physical port 1, the physical port 1 is identified as an infected physical port. In this connection, the destination MAC address is considered as an infected source MAC address. At this time, the infected source MAC address “00:11:22:aa:bb:cc” and the infected physical port 1 are output and displayed on the monitor 11 as worm infection information.

Referring back to FIG. 3, the block data 123 shows information on infected source MAC addresses (destination MAC addresses) of which communication is being blocked. The block data 124 shows information on physical ports of which communication is being blocked.

When new worm infection information is created, the worm detector 112 determines based on the “unit for blocking” of the setting data 121 which block data 123 or 124 should be updated. The block data 123, 124 are updated by adding the new worm infection information thereto, according to the determination result. When blocking is released, corresponding worm infection information is deleted, thereby updating the block data 123, 124.

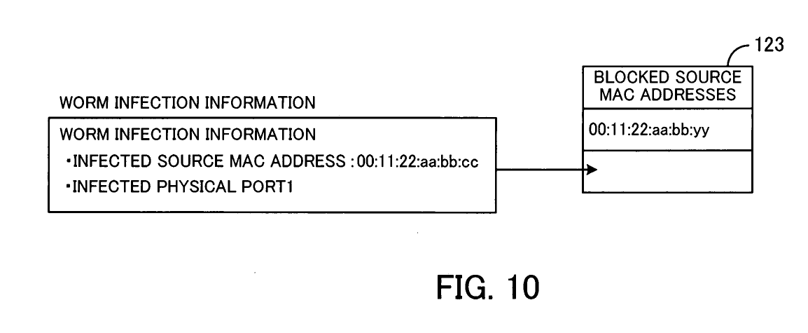

FIG. 10 shows a data structure of block data.

The block data 123 shows blocked source MAC addresses.

When the worm detector 112 outputs new worm infection information, the new infected source MAC address is set as a blocked source MAC address.

Referring to this figure, the new MAC address “00:11:22:aa:bb:cc” is set below a blocked source MAC address “00:11:22:aa:bb:yy”.

It should be noted that the block data 123 is not updated when worm infection information from the worm detector 112 shows a blocked source MAC address which is already set in the block data 123.

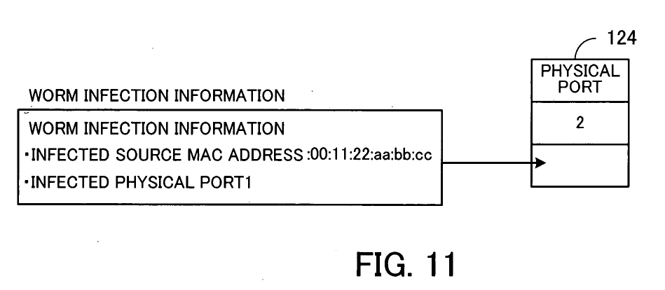

FIG. 11 shows a data structure of block data.

The block data 124 shows physical ports.

When the worm detector 112 outputs new worm infection information, the new infected physical port is set.

Referring to FIG. 11, the physical port 1 is newly set below a physical port 2.

It should be noted that the block data 124 is not updated when worm infection information from the worm detector 112 shows a physical port which is already set in the block data 124.

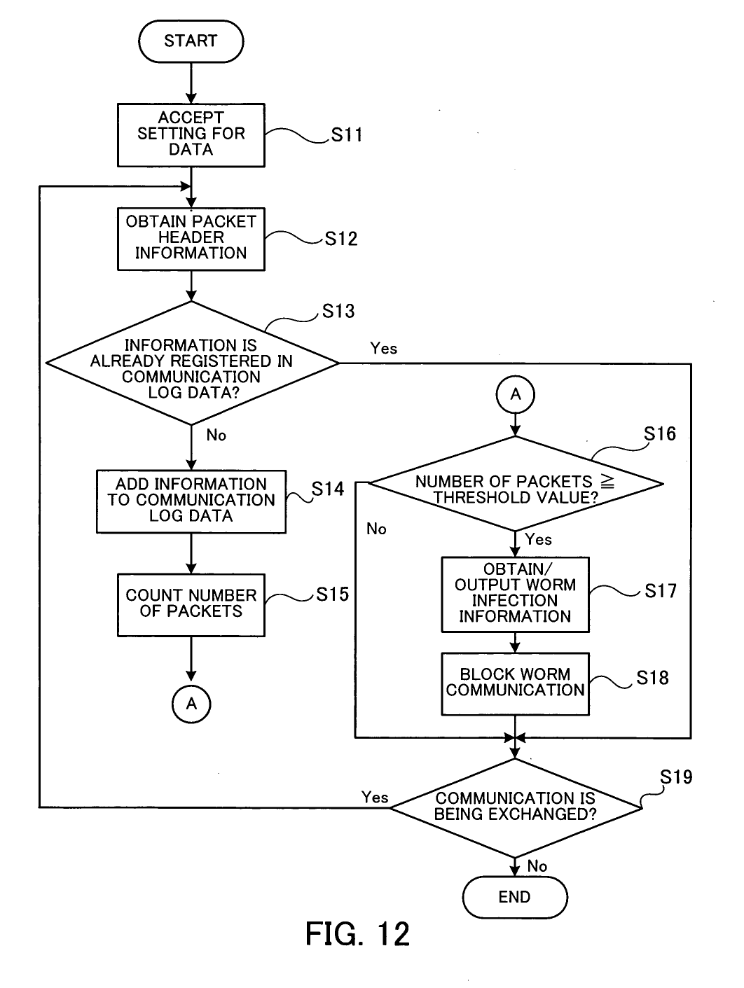

A worm detection process to be executed by the worm detection device 100 will be now described with reference to the flowchart of FIG. 12.

The communication acquisition section 111 accepts the setting for the setting data 121 (step S11). Then the communication acquisition section 111 monitors communication between the network segments 10 and 20, and extracts packet header information from the fixed-length header part of an acquired packet, the packet header information including a destination MAC address and a value set in the type field of the ICMP packet (step S12). Then the communication acquisition section 111 determines whether the extracted information is already registered in the communication log data 122 (step S13).

When the determination of step S13 results in Yes, the process goes on to step S19. When the determination of step S13 results in No, the packet header information is added to the communication log data 122 (step S14). Then the worm detector 112 counts the number of ICMP type3 packets appearing in a unit time specified by the setting data 121, for each destination MAC address (step S15), and determines whether the number of ICMP type3 packets is equal to or greater than a threshold value (step S16). When the determination of step S16 results in Yes, the worm detector 112 determines that the packet communication is worm communication, and then collects and outputs worm infection information including the infected source MAC address to the block data 123 or 124 (step S17).

Then the communication blocker 113 performs a communication blocking process to block the worm packet communication from the infected source MAC address (step S18).

When the determination of step S16 results in No, the packet communication is identified as uninfected and the process goes on to step S19. Then the worm detection device 100 determines whether communication is being exchanged (Step S19).

When the determination of step S19 results in Yes, the process goes back to step S12 to repeat the above process. When the determination of step S19 results in No, this worm detection process is completed.

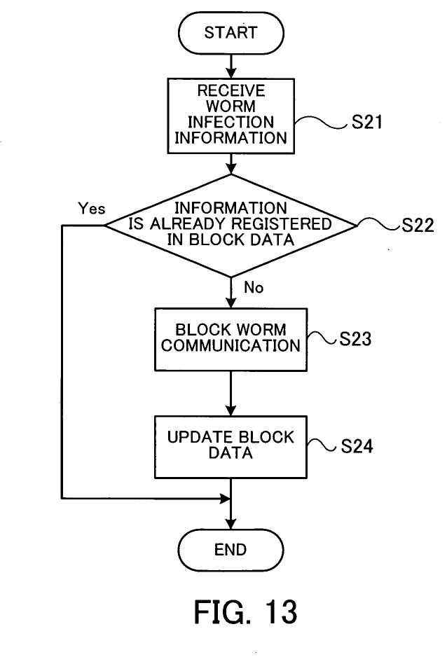

The communication blocking process to be executed by the worm detection device 100 will be now described with reference to the flowchart of FIG. 13.

The communication blocker 113 receives worm infection information (infected source MAC address and infected physical port) from the worm detector 112 and obtains information on which block data 123 or 124 should be updated (step S21).

Then the communication blocker 113 determines whether the received worm infection information is already registered in the specified block data 123, 124 (step S22).

When the determination of step S22 results in Yes, this communication blocking process is completed.

When the determination of step S22 results in No, the communication blocker 113 blocks the worm communication (step S23), and stores the worm infection information in the specified block data (step S24). Then the communication blocking process is completed.

As described above, the worm detection device 100 according to this embodiment is capable of determining whether communication is worm communication, only by counting the number of ICMP type3 packets for each destination MAC address, that is, based on little information.

Further, the worm detector can determine whether a source terminal is accessing a subnetwork which does not exist in a network, by obtaining ICMP type3 packets, without a network structure DB. Therefore, this embodiment is preferably usable for a large-scale network where a network structure varies often.

Still further, worms can be detected, without information of layer3 or over. Therefore, even a worm detection device with a Layer2 switch can detect worms easily and reliably. In other words, since the worm detection process is simply executed by the worm detection device with a simple hardware structure, the worm detection process can be made faster, thereby realizing high throughput.

Still further, since source MAC addresses outputting worm communication can be detected based on little information, that is, only by counting the number of ICMP type3 packets for each destination MAC address, the block data 123, 124 must be small.

Still further, since the block data 123, 124 is updated by adding worm infection information thereto, information on currently blocked source MAC addresses or currently blocked physical ports can be obtained, thus making it possible to suppress or avoid spread of worm infection more accurately.

Still further, only information in the fixed-length header part out of the packet 200, 210 is required for worm detection. In other words, a worm can be detected without analyzing a data body (payload part) that is a main part to be sent. This can shorten a time for reading the packet 200, 210 in the worm detection process, resulting in much faster process.

The processing functions described above can be realized by a computer. In this case, a worm detection program is prepared, which describes processes for the functions to be performed by the worm detection device 100. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVD), DVD-Random Access Memories (DVD-RAM), Compact Disc Read-Only Memories (CD-ROM), CD-R (Recordable)/RW (ReWritable), etc. The magneto-optical recording media include Magneto-Optical disks (MO) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to this invention, by obtaining destination address unreachable signals of packets for each source MAC address, it can be determined whether communication is worm communication. This means that worm communication can be detected with little information.

In addition, by obtaining information on destination address unreachable signals, the worm detector is capable of determining whether a source terminal is accessing a subnetwork which does not exist in a network, without a network structure DB. Therefore, this invention is preferably usable for a large-scale network where a network structure varies often.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium recording a worm detection program for monitoring communication of prescribed network segments being connected to a network and determining whether the communication is worm communication, the worm detection program causing a computer to function as:
communication acquisition means for obtaining information on a destination address unreachable signal of a packet for each source MAC address; and
worm detection means for determining whether the communication is the worm communication, based on the information on the destination address unreachable signal of the packet and worm criteria set for determining whether the communication is the worm communication, the information obtained by the communication acquisition means.

2. The computer-readable recording medium recording the worm detection program according to claim 1, wherein the destination address unreachable signal is a response signal to a signal output from a sender with the source MAC address.

3. The computer-readable recording medium recording the worm detection program according to claim 1, wherein the destination address unreachable signal is a response signal to an ICMP echo request output from a sender with the source MAC address.

4. The computer-readable recording medium recording the worm detection program according to claim 1, wherein the communication acquisition means extracts the information from a header part of the packet.

5. The computer readable recording medium recording the worm detection program according to claim 1, wherein the worm detection means determines that the communication is the worm communication when the number of destination address unreachable signals appearing in a unit time is equal to or greater than a prescribed value.

6. The computer readable recording medium recording the worm detection program according to claim 5, wherein the prescribed value is settable for the each source MAC address.

7. The computer-readable recording medium recording the worm detection program according to claim 5, wherein setting on whether to perform a worm detection process by the worm detection means can be made for the each source MAC address.

8. The computer-readable recording medium recording the worm detection program according to claim 1, wherein the program causes the computer to further function as communication blocking means for blocking the worm communication when the worm detection means determines that the communication is the worm communication.

9. A worm detection method for monitoring communication of prescribed network segments being connected to a network and determining whether the communication is worm communication, wherein:
communication acquisition means obtains information on a destination address unreachable signal of a packet for each source MAC address; and
worm detection means determines whether the communication is the worm communication, based on the information on the destination address unreachable signal of the packet and worm criteria set for determining whether the communication is the worm communication, the information obtained by the communication acquisition means.

10. A worm detection apparatus for monitoring communication of prescribed network segments being connected to a network and determining whether the communication is worm communication, comprising:
communication acquisition means for obtaining information on a destination address unreachable signal of a packet for each source MAC address; and
worm detection means for determining whether the communication is the worm communication, based on the information on the destination address unreachable signal of the packet and worm criteria set for determining whether the communication is the worm communication, the information obtained by the communication acquisition means.

11. The worm detection apparatus according to claim 10, further comprising a plurality of physical ports being connected to the network, wherein setting on whether to perform a worm detection process by the worm detection means can be made for each of the plurality of physical ports.

12. The worm detection apparatus according to claim 11, further comprising communication blocking means for blocking the worm communication when the worm detection means determines that the communication is the worm communication, wherein the communication blocking means blocks the worm communication on a source MAC address basis or on a physical port basis.
